(19) United States
(12) Patent Application Publication
(10) Pub. No.: US 2011/0187641 A1
(43) Pub. Date: Aug. 4, 2011

(54) COMPUTER POINTING DEVICE WITH MACRO FUNCTIONALITY

(76) Inventor: Shun-Pin Lin, Taipei County (TW)

(21) Appl. No.: 12/834,078

(22) Filed: Jul. 12, 2010

(30) Foreign Application Priority Data
Feb. 2, 2010 (TW) 099202131

(51) Int. Cl. G06F 3/033; G06F 3/048

(52) U.S. Cl. 345/157; 715/856

(57) ABSTRACT

A computer pointing device is adapted for use with a computer to control position of a cursor on a screen. The computer pointing device includes a casing, a macro key mounted operably on the casing, a storage medium disposed in the casing and storing a macro command, an execution module disposed in the casing, and a transmission interface. The macro command corresponds to the macro key and specifies an instruction set for controlling the cursor to move to a point defined by predetermined absolute coordinates on the screen. The execution module is coupled electrically to the macro key and the storage medium, and is operable to execute the macro command when the macro key is operated so as to generate an output signal corresponding to the macro command. The transmission interface is coupled electrically to the execution module and is operable to transmit the output signal to the computer.

### CROSS-REFERENCE TO RELATED APPLICATION

This application claims priority of Taiwanese application no. 099202131, filed on Feb. 2, 2010.

### BACKGROUND OF THE INVENTION

1. Field of the Invention

The invention relates to a pointing device, more particularly to a computer pointing device with macro functionality.

2. Description of the Related Art

A mouse is a pointing device for a computer to control a position of a cursor on a screen, and is provided with function keys for activating application programs or executing preconfigured functions.

Referring to FIG. 1, to identify the position of a cursor on a screen 121, absolute coordinates and relative coordinates may be used. The absolute coordinates are coordinate values of an input point (P1) relative to an origin point P0 (0, 0). On the other hand, the relative coordinates are difference values for an input point (P2) relative to a previous input point (P1). Since a conventional mouse is not configured to analyze the coordinates of a cursor, relative coordinates are generally adopted by the conventional mouse. The computer then moves the cursor on the screen according to the relative coordinate information received from the conventional mouse.

It is noted that a conventional computer may have macro recording functionality to enhance utilization efficiency of a computer pointing device. A macro command is a batch command for batch processing and associates a series of key actions with a single key or instruction operation to satisfy a user's habit or a program requirement.

However, macro commands are specific to a computer that has been configured therewith. Once the user switches to another computer or system, there is a need to perform macro recording anew, which arises in user inconvenience.

Moreover, actual cursor movement based on relative coordinate information depends on factors, such as the acceleration corresponding to the displacement amount, the acceleration parameter and characteristics of the computer operating system. Thus, a macro command for cursor position control based on relative coordinate information may be very complex such that it is difficult for an ordinary user to configure such settings by himself or herself.

### SUMMARY OF THE INVENTION

Therefore, an object of the present invention is to provide a computer pointing device with macro functionality that can overcome at least one of the above disadvantages of the prior art.

According to the present invention, there is provided a computer pointing device adapted for use with a computer to control position of a cursor on a screen. The computer pointing device includes a casing and a macro key mounted operably on the casing. A storage medium and an execution module are disposed in the casing, and a transmission interface is coupled electrically to the execution module. The storage medium stores a macro command corresponding to the macro key and specifying an instruction set for controlling the cursor to move to a point defined by predetermined absolute coordinates on the screen. The execution module is coupled electrically to the macro key and the storage medium, and is operable to execute the macro command when the macro key is operated so as to generate an output signal corresponding to the macro command. The transmission interface transmits the output signal to the computer.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic diagram for illustrating use of relative coordinates and absolute coordinates to define cursor position on a screen;

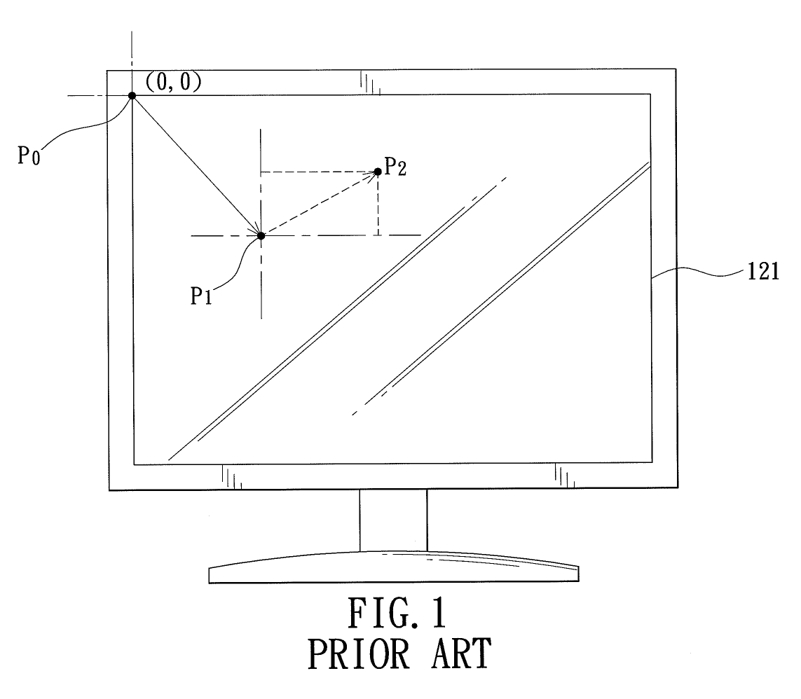

FIG. 2 is a perspective view for illustrating the preferred embodiment of a computer pointing device with macro functionality according to the present invention when used with a computer; and

FIG. 3 is a system block diagram of the preferred embodiment.

### DETAILED DESCRIPTION OF THE PREFERRED EMBODIMENT

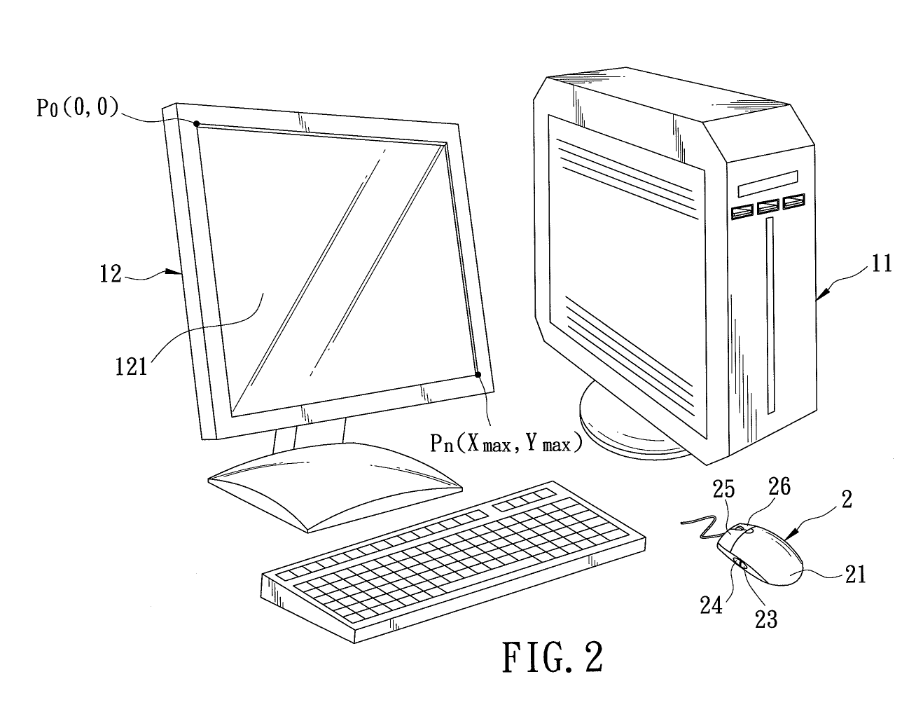

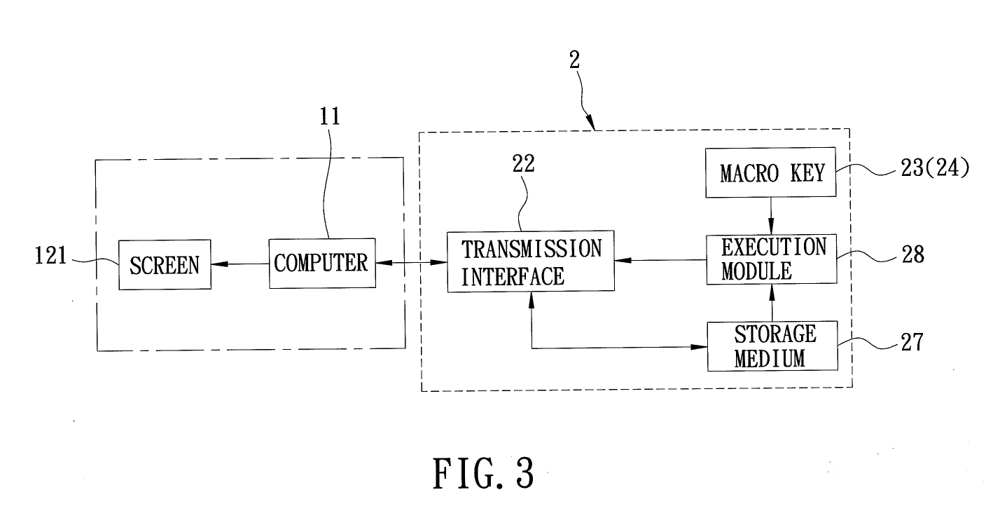

Referring to FIGS. 2 and 3, the preferred embodiment of a computer pointing device 2 with macro functionality according to the present invention is shown to be adapted for use with a computer 11 that is operatively coupled to a display 12. The display 12 includes a screen 121 that has a minimum X-coordinate (Xₘᵢₙ), a minimum Y-coordinate (Yₘᵢₙ), a maximum X-coordinate (Xₘₐₓ), and a maximum Y-coordinate (Yₘₐₓ) The minimum X-coordinate (Xₘᵢₙ) and the minimum Y-coordinate (Yₘᵢₙ) correspond to an upper left corner of the screen 121, and the maximum X-coordinate (Xₘₐₓ) and the maximum Y-coordinate (Yₘₐₓ) correspond to a lower right corner of the screen 121.

The computer pointing device 2 includes a casing 21, a first macro key 23 mounted operably on the casing 21, and a storage medium 27 and an execution module 28 disposed in the casing 21. A transmission interface 22 is coupled electrically to the execution module 28. The storage medium 27 stores a first macro command, which corresponds to the first macro key 23 and which specifies an instruction set for controlling the cursor to move to a point defined by predetermined absolute coordinates on the screen 121. The computer pointing device 2 further includes buttons 25 and 26, which are mounted operably on the casing 21 and which serve as left and right function buttons.

The execution module 28 is coupled electrically to the first macro key 23 and the storage medium 27, and executes the first macro command when the first macro key 23 is operated so as to generate a first output signal corresponding to the first macro command. The transmission interface 22 transmits the first output signal from the execution module 28 to the computer 11, thereby enabling the computer 11 to move the cursor to the point defined by the predetermined absolute coordinates on the screen 121.

The execution module 28 may be realized using wired logics, circuits, firmware or a microprocessor executing proprietary program instructions, which may be readily appreciated by those skilled in the art and which will not be detailed herein for the sake of brevity.

As an example, the first macro command may specify an instruction set for controlling the cursor to move to the absolute coordinates (640, 512) on the screen 121.

In this embodiment, the transmission interface 22 is also coupled to the storage medium 27 so that the first macro command may be configured in the storage medium 27 by the computer 11 through the transmission interface 22. Preferably, the storage medium 27 may be a flash memory for storing at least one macro command. As an example, a macro command may be imported from the computer 11 for storage in the storage medium 27. As another example, the computer 11 may execute an application program to define the macro command to be assigned to the first macro key 23.

In this embodiment, the computer pointing device 2 further includes a second macro key 24 mounted operably on the casing 21. The storage medium 27 further stores a second macro command corresponding to the second macro key 24 and specifying another instruction set for controlling the cursor to move from one point defined using predetermined absolute coordinates on the screen 121 to another point defined using different absolute coordinates on the screen 121 and for selecting a square region on the screen 121, such as a square or rectangular region, containing said one point and said another point. The execution module 28 is coupled electrically to the second macro key 24 and executes the second macro command when the second macro key 24 is operated so as to generate a second output signal corresponding to the second macro command and transmitted to the computer 11 via the transmission interface 22.

As an example, the second macro command may specify an instruction set for controlling the cursor to be displaced from the absolute coordinates (0, 0) to the absolute coordinates (1280, 1024) and for selecting a region on the screen 121 containing the absolute coordinates (0, 0) and (1280, 1024). In other words, the second macro command corresponds to the actions of clicking on the button 25 (the left function button) while the cursor is at the point (0, 0) and moving the cursor from the point (0, 0) to the point (1280, 1024) to select a region on the screen 121 that contains the point (0, 0) and the point (1280, 1024).

The computer 11 may execute an application program to define the macro command to be assigned to the second macro key 24 in the same manner for the first macro key 23 as mentioned above.

Preferably, the execution module 28 is configured with program instructions for setting opposite diagonal corners of the screen 121 as minimum and maximum absolute coordinates of the screen 121, i.e., P0 (Xₘᵢₙ, Yₘᵢₙ) and Pn (Xₘₐₓ, Yₘₐₓ)

As an example, the program instructions may configure P0 (Xₘᵢₙ, Yₘᵢₙ) with the minimum absolute X-coordinate (Xₘᵢₙ) of 0 and the minimum absolute Y-coordinate (Yₘᵢₙ) of 0 such that the upper left corner of the screen 121 serves as an origin point (0, 0) of the absolute coordinates, and Pn(Xₘₐₓ, Yₘₐₓ) with the maximum absolute X-coordinate (Xₘₐₓ) Of 1280 and the maximum absolute Y-coordinate (Yₘₐₓ) of 1024 to correspond to the lower right corner of the screen 121. Scaling may then be performed to fit the current resolution of the screen 121.

It is apparent from the foregoing that, when the computer pointing device 2 is connected to the computer 11 through the transmission interface 22, the cursor may be instantly moved to the position defined by the absolute coordinates (640, 512) when the first macro key 23 is operated regardless of the initial position of the cursor on the screen 121. Moreover, an operation for selecting a specific region on the screen 121 may also be completed immediately when the second macro key 24 is operated.

In other embodiments, other macro commands may as well be configured, such as moving back to an original position after moving through a series of points defined by corresponding absolute coordinates.

Preferably, the transmission interface 22 is one of a wired transmission interface and a wireless transmission interface. The transmission interface 22 may be a wired interface complying with wired connectivity standards, such as RS-232C, PS/2, ADB or USB, or a wireless interface complying with wireless connectivity standards, such as infrared radiation (IrDA) or radio (including Bluetooth).

The computer pointing device 2 of this embodiment is exemplified as a mouse that includes means, i.e., a coordinate signal generator (not shown), for generating relative coordinate signals to be transmitted to the computer 11 via the transmission interface 22 for cursor position control in a conventional manner. Since the feature of the present invention does not reside in generation of the relative coordinate signals, which is known in the art, further details of the same will be omitted for the sake of brevity.

Accordingly, a cursor may be moved instantly, a target object may be easily selected, and a specific operation or a series of consecutive operations may be readily and conveniently performed through the computer pointing device 2 with macro functionality of this invention. Since the macro commands are specific to the computer pointing device 2, macro recording need not be repeatedly performed when the computer pointing device 2 is used with different computers 11.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A computer pointing device adapted for use with a computer to control position of a cursor on a screen, said computer pointing device comprising:
a casing;
a first macro key mounted operably on said casing;
a storage medium disposed in said casing and storing a first macro command, said first macro command corresponding to said first macro key and specifying an instruction set for controlling the cursor to move to a point defined by predetermined absolute coordinates on the screen;
an execution module disposed in said casing, coupled electrically to said first macro key and said storage medium, and operable to execute said first macro command when said first macro key is operated so as to generate a first output signal corresponding to said first macro command; and
a transmission interface coupled electrically to said execution module and operable to transmit the first output signal to the computer.

2. The computer pointing device as claimed in claim 1, wherein said transmission interface is further coupled to said storage medium, and said first macro command is configured in said storage medium by the computer through said transmission interface.

3. The computer pointing device as claimed in claim 1, further comprising a second macro key mounted operably on said casing, said storage medium further storing a second macro command, said second macro command corresponding to said second macro key and specifying another instruction set for controlling the cursor to move from one point defined using predetermined absolute coordinates on the screen to another point defined using different absolute coordinates on the screen and for selecting a region on the screen containing said one point and said another point, said execution module being coupled electrically to said second macro key and being operable to execute said second macro command when said second macro key is operated so as to generate a second output signal corresponding to said second macro command and transmitted to the computer via said transmission interface.

4. The computer pointing device as claimed in claim 1, wherein said execution module is configured with program instructions for setting opposite diagonal corners of the screen as minimum and maximum absolute coordinates of the screen.

5. The computer pointing device as claimed in claim 1, wherein said transmission interface is one of a wired transmission interface and a wireless transmission interface.
